(19) United States
(12) Patent Application Publication
(10) Pub. No.: US 2003/0007052 A1
(43) Pub. Date: Jan. 9, 2003

(54) Method of preparing an inkjet ink imaged lithographic printing plate

(75) Inventors: Jianbing Huang, Trumbull, CT (US); Shashikant Saraiya, Parlin, NJ (US); S. Peter Pappas, Juno Beach, FL (US)

Correspondence Address: Vazken Alexanian, Ohlandt, Greeley, Ruggiero & Perle, L.L.P., One Landmark Square, 10th Floor, Stamford, CT, 06901-2682, US

(73) Assignee: Kodak Polychrome Graphics, L.L.C., Norwalk, CT

(21) Appl. No.: 09/860,814

(22) Filed: May 18, 2001

(51) Int. Cl. B41J 2/01

(52) U.S. Cl. 347/101

(57) ABSTRACT

The present invention includes a method of preparing an inkjet ink imaged lithographic printing plate, comprising the steps of: imagewise applying onto a substrate coated with an inkjet ink reactive coating composition comprising a diazonium material, an inkjet ink to produce an imaged coated substrate wherein the inkjet ink imaged regions are oleophilic and more developer-insoluble than non-imaged regions; and contacting said imaged and non-imaged regions of said an imaged coated substrate and an aqueous developer to selectively remove said coating from said developer soluble non-imaged regions. The present invention also includes a lithographic printing plate, such as an inkjet ink imaged lithographic printing plate, which is prepared by the method of the present invention.

### BACKGROUND OF THE INVENTION

1. Field of the Invention

The present invention relates to a method of preparing an inkjet ink imaged lithographic printing plate. More particularly, the present invention relates to a method of preparing an inkjet ink imaged lithographic printing plate in which a diazonium salt condensate is insolubilized upon contact with one or more active ingredients of the inkjet ink to produce regions that are less soluble in a developer than the regions not contacted with the one or more active ingredients.

2. Description of the Prior Art

A variety of methods of preparing imaged lithographic printing plates based upon insolublization of exposed regions are known in the art. The insolublization can be achieved by a variety of reactions, including inkjets. A number of these methods use inkjet machines to deposit an ink-receptive image onto a hydrophilic substrate.

In general, these direct approaches can suffer from poor image quality due to non-uniformity of the image coating formed by individual droplets, unwanted lateral spreading, excessive coating thickness due to large droplet volumes in the case of solvent-free ink compositions. For example, a 3 picoliter inkjet ink droplet has approximately the same volume as a cube of 14 micron side. Films formed from such inkjet droplets will have a film thickness of 14 microns, which is far more than a typical thickness of 1-3 microns for lithographic printing plates. Excessive coating thickness is expected to cause problems such as poor resolution and severe dot gain.

There are a number of indirect approaches described in the prior art, which are briefly summarized below.

U.S. Pat. No. 5,260,163 describes diffusion of a reactant from inkjet inks into a plate coating and reaction with the plate coating. The reaction produces plate coating that is more developable to a developer liquid. In contrast, the reaction in the present invention reduces the developability of the plate coating.

U.S. Pat. No. 5,275,689 describes diffusion of a reactant from inkjet inks into a plate coating and reaction therewith. The acid is delivered by the inkjet ink. The acid-catalyzed reaction produces a plate coating that is more developable to a developer liquid. In contrast, the reaction in the present invention reduces the developability of the plate coating.

U.S. Pat. No. 5,466,653 describes diffusion of a reactant from inkjet inks into a non-photosensitive plate coating and subsequent reaction by an esterification reaction between COOH and a methylating agent. This causes the plate coating to become less developable in a developer liquid.

U.S. Pat. No. 5,695,908 involves diffusion of a reactant from inkjet inks into a plate coating to produce a complex by a chelating reaction between metal ions from the ink and functional groups on the binder of the plate coatings. The resulting complex is insoluble in water, which allows removal of the plate coating in the area not covered by the ink.

U.S. Pat. No. 5,750,314 describes a method of applying a developer-insoluble inkjet ink onto a developer-soluble plate coating. The inkjet ink images form a mask that prevents developer from reaching the developer-soluble coating in the areas covered by the inkjet ink. This method of masking would suffer from poor image quality due to undercutting.

The commonly owned U.S. Pat. No. 6,050,193 describes a developable plate coating. The developability of this plate coating is selectively reduced by contact with inkjet ink. The ink composition includes a sol-precursor, such as, a multi-acetoxy silane, which can undergo self-condensation to form a particulate material or condensation with the plate coating.

The commonly owned U.S. Pat. No. 6,131,514 describes an inkjet composition containing water soluble polymers which can bind with surface groups on the plate through the water-soluble groups, resulting in insolubilization of the polymer in the inkjet ink. The ink-receptive image area of the press-ready plate is primarily made of materials from the inkjet inks. The present invention does not use polymeric materials from the inkjet ink.

The commonly owned U.S. Pat. No. 6,187,380 B1 describes a printing plate produced directly by reactants which polymerize alone or in combination with other reactants precoated on the plate substrate to form a printable hard resin image. In one embodiment, ink jet liquid droplets from one or more printer heads are introduced onto the surface of the printing plate, where the droplets polymerize to form a printable image comprising a resin. The present invention does not use polymerizable materials or polymerization initiators from the inkjet ink to produce developer-insoluble imaged regions.

None of the reference of the prior art discloses a method in which an inkjet ink reactive coating composition comprising a diazonium condensate is insolubilized by one or more active ingredients of an inkjet ink to produce the inkjet ink imaged lithographic printing plates of the present invention.

Accordingly, it is an object of the present invention to provide a simple method of preparing a lithographic printing plate using commercial inkjet printers.

### SUMMARY OF THE INVENTION

The present invention includes a method of preparing an inkjet ink imaged lithographic printing plate, comprising the steps of:

imagewise applying onto a substrate coated with an inkjet ink reactive coating composition comprising a diazonium material, an inkjet ink to produce an imaged coated substrate wherein the inkjet ink imaged regions are oleophilic and more developer-insoluble than non-imaged regions; and

contacting the imaged and non-imaged regions of the imaged coated substrate and an aqueous developer to selectively remove the coating from the developer soluble non-imaged regions.

The present invention further includes a method of preparing an inkjet ink imaged lithographic printing plate, comprising the steps of:

applying onto a substrate an inkjet ink reactive coating composition, which can be insolubilized by one or more active ingredients of the inkjet ink, to produce a coated substrate;

applying onto the coated substrate an inkjet ink image to produce, after a sufficient time at a sufficient temperature, an imaged coated substrate having developer-insoluble imaged regions and developer-soluble non-imaged regions; and

contacting the imaged and non-imaged regions of the imaged coated substrate and a developer to selectively remove the coating from the developer soluble non-imaged regions and produce the inkjet ink imaged lithographic printing plate.

The present invention still further includes a method of preparing an inkjet ink imaged lithographic printing plate, comprising the steps of:

imagewise applying onto a substrate coated with an inkjet ink reactive coating composition comprising a diazonium condensate, which can be insolubilized by one or more active ingredients of the inkjet ink, an inkjet ink to produce, after a sufficient time at a sufficient temperature, an imaged coated substrate having oleophilic developer-insoluble imaged regions and developer-soluble non-imaged regions; and

contacting the imaged and non-imaged regions of the imaged coated substrate and a developer to selectively remove the coating from the developer soluble non-imaged regions.

The present invention also includes a lithographic printing plate, such as an inkjet ink imaged lithographic printing plate, which is prepared by any of the methods of the present invention.

The invention provides the following advantages:

(1) the present invention does not require replacing the original inks from commercial printers;

(2) use of original inks from commercial printers reduces the risk of damaging printer hardware and helps to obtain high quality images;

(3) the image area of the imaged plate of the present invention comprises a thin uniform coating from the original plate coating, which is more uniform than the inkjet film formed by individual droplets;

(4) once above a threshold of reactant required by the insolubilization of the plate coating, the excess reactant from the inkjet ink can be removed during the development step;

(5) the step of removing excess ink can be achieved on press; and

(6) the present invention provides post-curing of the plate coating after the ink and the plate coating in the area not covered by the ink have been removed.

### DETAILED DESCRIPTION OF THE INVENTION

Ink receptive areas are generated on the surface of a hydrophilic surface. When the surface is moistened with water and then ink is applied, the hydrophilic background areas retain the water and repel the ink. The ink receptive areas accept the ink and repel the water. The ink is transferred to the surface of a material upon which the image is to be reproduced. Typically, the ink is first transferred to an intermediate blanket, which in turn transfers the ink to the surface of the material upon which the image is thereafter reproduced.

Lithographic printing plate precursors, i.e., imageable elements, typically include a radiation-sensitive coating applied over the hydrophilic surface of a support material. If after exposure to radiation, the exposed regions of the coating become the ink-receptive image regions, the plate is called a negative-working printing plate. Conversely, if the unexposed regions of the coating become the ink-receptive image regions, the plate is called a positive-working plate.

In the present invention, the imagewise inkjet ink exposed regions are rendered less soluble or dispersible in a developer and become the ink-receptive image areas. The unexposed regions, being more readily soluble or dispersible in the developer, are removed in the development process, thereby revealing a hydrophilic surface, which readily accepts water and becomes the ink-repellant image area. In each instance, the regions of the radiation-sensitive layer that remain (i.e., the image areas) are ink-receptive and the regions of the hydrophilic surface revealed by the developing process accept water and repel ink.

The present invention is useful in negative-working printing plates.

In the method of preparing an inkjet ink imaged lithographic printing plate according to the present invention, the first step is applying an inkjet ink reactive coating composition onto a substrate to produce a substrate that is coated with the inkjet ink reactive composition. The inkjet ink reactive composition comprises a diazonium material, which can be insolubilized by one or more active ingredients of the inkjet ink, such as, basic materials and reducing agents.

Preferably, the diazonium material is a diazonium condensate, which is the condensation product of an aromatic diazonium salt and a condensation agent. The condensation agent can be formaldehyde, bis-(alkoxymethyl) diphenyl ether, such as, bis-(methoxymethyl) diphenyl ether or a combination thereof. Other condensation agents that are suitable for use in the present invention are the condensation agents described in U.S. Pat. No. 3,867,147, the contents of which are incorporated herein by reference.

The aromatic diazonium salt has a counteranion which can be a benzene sulfonate, toluene sulfonate, mesitylene sulfonate, sulfate, bisulfate, chloride, tetrafluoroborate, hexafluorophosphate, hexafluoroantimonate, hexafluoroarsenate, methanesulfonate, trifluoromethane sulfonate, naphthalene sulfonate and alkyl derivatives, zinc chloride, tetraarylborate, alkyltriarylborate, 2-hydroxy-4-methoxybenzophenone-5-sulfonate, dihydrogen phosphate or a combination thereof. Adducts formed from diazonium materials having a plurality of diazonium groups and polymeric materials having a plurality of sulfonate groups can also be used.

Exemplary substituents which may be linked to the aromatic nuclei of the diazonium salt to produce substituted aromatic diazonium salts include one or more of the following:

methoxy, difluoromethoxy, ethoxy, hydroxyethoxy, ethoxyethoxy, methyl, propyl, isobutyl, trifluoromethyl, fluorine, chlorine, bromine, iodine, amidocarbonyl, phenoxycarbonyl, acetyl, methanesulfonyl, ethanesulfonyl, acetylamino, methylamino, ethylamino, dimethylamino, diethylamino, methylethylamino, phenylamino, benzylamino, methylbenzylamino and ethylbenzylamino.

Preferably, the aromatic diazonium salt is 4-diazodiphenylamine (4-phenylaminobenzenediazonium) sulfate or bisulfate, 3-alkoxy-4-diazo-diphenylamine salts having 1 to 3 carbon atoms in the alkoxy group, such as, 3-methoxy-4-diazo-diphenylamine and a combination thereof. However, any aromatic diazonium salt can be used. Examples of such aromatic diazonium salts include:

diphenyl-4-diazoniumchloride; 2-4-(N-(naphthyl-2-methyl)-N-propylamino)benzenediazoniumsulfate; chloro-diphenyl-4-diazoniumchloride; 4-(3-phenylpropylamino)-benzenediazoniumsulfate; 4-(N-ethyl-N-(benzyl)-amino)-benzenediazoniumchloride; 4-(N,N-dmethyl-amino)-benzenediazoniumtetra fluoroborate; 4-(N-(3-phenyl-mercapto-propyl)-N-ethyl-amino)-2-chlorobenzenediazoniumchloride; 4-(4-methylphenoxy)benzenediazoniumsulfate; 4-(phenylmercapto)-benzenediazoniumchloride; 4-phenoxybenzenediazoniumchloride; 4-(benzoylamino)-benzenediazoniumhexafluorophosphate; methylcarbazoie-3-diazoniumchloride; 3-methyl-diphenyleneoxide-2-diazoniumchloride; 3-methyidiphenylamine-4-diazoniumsulfate, 2,3′,5-trimethoxy-diphenyl-4-diazoniumchloride; 2,4′,5-triethoxy-diphenyl-4-diazoniumchloride; 4-(3-(3-methoxy-phenyl)-propylamino)-benzenediazoniumsulfate; 4-(N-ethyl-N-(4-methoxy-benzyl)-amino)-benzenediazoniumchloride; 4-(N-(naphthyl-(2)-methyl)-N-n-propylamino)methoxybenzenediazoniumsulfate; 4-(N-(3-phenoxy-propyl)-N-methyl-amino)-2,5-dimethoxy-benzenediazoniumtetra fluoroborate; 4-(N-(3-phenyl-mercapto-propyl)-N-ethyl-amino)-2-chloro-5-methoxybenzenediazoniumchloride; 4-(4-(3-methyl-phenoxy)-phenoxy)-2,5-dimethoxy-benzene-diazoniumsulfate; 4-(4-methoxy-phenylmercapto)-2,5-diethoxy-benzenediazoniumchloride; 2,5-diethoxy-4-phenoxy-benzenediazoniumchloride; 4-(3,5-dimethoxy-benzoylamino)-2,5-diethoxy-benzenediazoniumhexafluorophosphate; methoxycarbazole-3-diazoniumchloride; 3-methoxy-diphenyleneoxide-2-diazoniumchloride; methoxydiphenylamine-4-diazoniumsulfate; diazonium salts derived from the following amines: 4-amino-diphenylamine, 4-amino-3-methyl-diphenylamine, 4-amino-3-ethyldiphenylamine, 4′-amino-3-methyl-diphenylamine, 4′-amino-4-methyl-diphenylamine, 4′-amino-3,3′-dimethyl-diphenylamine, 3′-chloro-4-amino-diphenylamine, 4-amino-diphenylamine-2-sulfonic acid, 4-amino-diphenylamine-2-carboxylic acid, 4-aminodiphenyl-amine-2′-carboxylic acid, 4′-bromo-4-amino-diphenylamine, 4-amino-3-methoxy-diphenylamine, 4-amino-2-methoxy-diphenylamine, 4′-amino-2-methoxy-diphenylamine, 4′-amino-4-methoxydiphenylamine, 4-amino-3-ethoxy-diphenylamine, 4-amino-3-hexyloxy-diphenylamine, 4-amino-3-.beta.-hydroxy-ethoxy-diphenylamine, 4′-amino-2-methoxy-5-methyl-diphenylamine, 4-amino-3-methoxy-6-methyl-diphenylamine, 4′-amino-4-n-butoxy-diphenylamine and 4′-amino-3′,4-dimethoxy-diphenylamine; and any combination of these diazonium salts.

Inkjet ink reactive composition may include optional ingredients such as binder materials, surfactants, stabilizers and colorants.

A person of ordinary skill in the art would know how to use other aromatic compounds and other counteranions to obtain an aromatic diazonium salt that is suitable for use in the method of the present invention.

The inkjet ink reactive coating composition is applied onto a lithographic substrate, such as, an aluminum sheet, polyester or paper. The aluminum sheet is preferably prepared by a method, such as, decreasing, electrochemical roughening, anodizing, treatment with poly vinyl phosphonic acid or silicate or a combination of two or more of these methods.

In the second step of the method of the present invention, after coating the substrate, an inkjet ink image is applied onto the coated substrate. After a sufficient time at a sufficient temperature, the reaction between the diazonium material and one or more active ingredients from the ink is substantially complete. Typically, the time needed for a substantially complete reaction is from about I second to about 30 minutes at ambient or superambient temperature, i.e., from room temperature to about 95° C. Accordingly, after applying the inkjet ink onto the coated substrate about 1 second to about 30 minutes is allowed to expire before application of the developer.

After a substantially complete reaction at ambient or super-ambient temperatures, a coated substrate having developer-insoluble imaged regions and developer-soluble non-imaged regions are produced.

Preferably, the inkjet ink ingredient, which reacts with the diazonium material, is a nucleophilic material such as bases and reducing agents.

In a preferred embodiment of the present invention, inkjet ink comprises: up to 2 wt % of triethanolamine; up to 15 wt % of diethyleneglycol mono butyl ether; up to 15 wt % of glycerol; up to 2 wt % of diethyleneglycol; up to 10 wt % of 2-pyrrolidinone and up to 85 wt % of water.

Both organic and inorganic bases may be used. Useful inorganic bases include potassium hydroxide, sodium hydroxide, ammonium hydroxide, potassium phosphate, sodium phosphate, sodium borate and potassium borate. Useful organic bases include amines and carboxylates containing counter ions selected from the group of alkali metal ions, tetraalkyl ammonium ions, diaryliodonium ions and triaryl sulfonium ions.

Suitable amines include organic amines, which are reactive with the diazonium material, i.e., can decompose diazonium material. Any organic amine is suitable. The organic amine can be a primary, secondary or tertiary amine of 1 to 22 carbon atoms or a quaternary ammonium hydroxide or alkoxide thereof. Examples of such suitable amines include, but are not limited to: triethylamine, dimethylbenzylamine, diethylbenzylamine, dimethylaniline diethylaniline, dimethylaminopyridine, diethylaminopyridine, tetramethylguanidine, guanidine, dipropylamine, diisopropylamine, tripropylamine, triisopropylamine, dibutylamine, tributylamine, dioctylamine, trioctylamine, monoethanolamine, diethanolamine, triethanolamine, pyridine, pyrrole, isomers thereof, quaternary ammonium hydroxides thereof, quaternary ammonium alkoxides thereof, quaternary ammonium carboxylates thereof and a combination of any of the preceding compounds. Trialkylamines having a linear branched or cyclc alkyl of 1-12 carbon atoms, including hydroxy-substituted derivatives thereof, are preferred.

Examples of suitable carboxylates include sodium acetate, sodium citrate, and polymers carrying carboxylate groups.

Suitable reducing agents include mercaptans, sulfides, thiosulphate, phosphines, aldehydes, hydrazines or combination thereof.

The amount of nucleophilic reactants in the inkjet ink composition should be sufficient to cause substantial change in developability of the inkjet ink reactive composition. The optimal amount depends on the inkjet droplet volume, equivalent weight and the coating thickness of the inkjet ink reactive coating. In the event of using bases as nucleophilic reactants, the amount of bases in the ink can be measured by potentiometric titration. It should be noted that commonly used pH value is not a good indicator of the amount of bases in a composition.

Inkjet ink composition may also include water-miscible organic solvents that can swell the inkjet ink reactive composition and thereby help nucleophilic reactants from the ink to penetrate into the inkjet ink reactive composition. Examplary water-miscible organic solvents are N,N-dimethylformamide, N,N-dimethyl acetamide, N-methyl pyrrolidinone, methyl lactate, ethyl lactate, phenoxy ethanol, benzyl alcohol, and butoxy ethanol. Some of these solvents are miscible with water only in the presence of surfactants.

The preferred inkjet ink ingredients are a combination of triethanolamine and 2-pyrrolidinone both of which being present in the inkjet ink of the commercially available black ink of Epson Stylus 740. The black ink of Epson Stylus 740 has a pH of about 9.0.

In the third step of the method of the present invention, after the inkjet ink image is applied onto the coated substrate and the diazonium material and the one or more active ingredients, i.e., amine and pyrrolidinone are allowed to react, the imaged and non-imaged regions of the coated substrate and a developer are contacted.

The pH of the aqueous developer is preferably within about 5 to about 14, depending on the nature of the graft copolymer composition. However, water alone can also be used to remove the coating from the water soluble non-imaged regions, as well as unreacted ink from the imaged regions.

The developer is preferably an aqueous alkali developer, such as those commonly used in lithography. Common components of aqueous developers include surfactants, chelating agents, such as salts of ethylenediamine tetraacetic acid, organic solvents, such as benzyl alcohol, and alkaline components, such as, inorganic metasilicates, organic metasilicates, hydroxides and bicarbonates.

The step of contacting described above selectively removes the coating from the non-imaged regions, which are developer soluble, along with any unreacted ink from the imaged regions. This step is achieved without removing the imaged regions, which are insolubilized as a result of reaction between the diazonium material and, for example, the amine ingredient of the ink to produce the inkjet ink imaged lithographic printing plate of the present invention.

Thus, the imaged regions, which are insolubilized as a result of reaction between the diazonium material and, for example, the amine ingredient of the ink, preferably in the presence of the other ingredients, produce an inkjet ink imaged lithographic printing plate in which the insolubilized regions become the ink recipient regions during printing.

The method of the present invention further includes an optional post curing step of the developer-insoluble imaged regions after the water wash step. Post curing can be used to increase press life. The post curing can be carried out by exposing the imaged and non-imaged regions to heat, actinic radiation, or a combination of heat and actinic radiation, such as, ultraviolet radiation, at an ambient or super-ambient temperature. The step of exposing to heat is typically carried out for a period of time from about 1 second to about 30 minutes at a temperature about 100° C. to about 250° C.

One of the advantages of the present method is that post curing of the developer-insoluble imaged regions can be carried out after removing the developer-soluble imaged regions.

The present invention is useful in lithographic plate-making, especially in smaller print shops where it is desirable to implement low-capital computer-to-plate workflows.

### EPSON-740 Black and Color Cartridges were Titrated Against 0.1N HCl Solution

Black cartridge #S020189

Color cartridge #S020191/1C3CL01 contains Diethylene glycol

| | Sample weight in | | 0.1 HCI required for tritration |
|---|---|---|---|
| Color | gram + H₂O | Initial pH | to Bring to pH 4.0 |
| Black | 5.0 + 45 gr H₂O | 8.76 | 13 ml |
| Magenta | 5.0 + 45 gr H₂O | 8.70 | 6.75 ml |
| Yellow | 5.0 + 45 gr H₂O | 8.20 | 1.1 ml |
| Cyan | 5.0 + 45 gr H₂O | 8.57 | 3.0 ml |

Comment:
Red, Yellow and blue color solutions seems like lower in solid than black color

### EXAMPLE 1

An aluminum sheet prepared by decreasing, electrochemical roughening, anodizing and treatment with polyvinyl phosphonic acid acid, was coated with the following composition using a whirl coater spinning at 80 rpm for 3 min.:

390 g Dl water;

8 g DTS-18 (condensate of formaldehyde and 4-phenylamino benzene diazonium bisulfate, supplied by PCAS, France).

10 drops of 4% FC-430 in 2-methoxyethanol (FC-430 is a fluorocarbon surfactant product of 3M).

The coated plate was fed through an Epson Stylus 740 printer, which deposited a pattern of black inks. The imaged plates were washed with tap water to remove the inkjet ink and the coating in the area not covered by the inkjet inks. The coating covered by the inkjet inks remained after water rinsing, and provided ink-receptive portions of a lithographic printing plate.

### EXAMPLE 2 (COMPARATIVE)

The procedure of Example 1 was repeated with Epson cyan ink replacing the black ink in Example 1. Little DTS-18 coating remained in the area covered by the cyan ink.

### EXAMPLE 3 (COMPARATIVE)

The procedure of Example 1 was repeated with Epson yellow ink replacing the black ink in Example 1. No DTS-18 coating remained in the area covered by the yellow ink.

### EXAMPLE 4

The procedure of example 1 was repeated with Epson magenta ink replacing the black ink in Example 1. Some DTS-18 coating remained in the area covered by the magenta ink.

### EXAMPLE 5 (COMPARATIVE)

The procedure of Example 1 was repeated with HP Deskjet 695C replacing Epson stylus 740 printer in Example 1. No DTS-18 coating remained in the area covered by the black ink from the HP printer.

### EXAMPLE 6

An aluminum sheet prepared by decreasing, anodizing and silicate treatment, was coated with the following composition using #5 wire-round laboratory coating bar:

5 g Dl water;

95 g DTS-18 (condensate of formaldehyde and 4-phenylamino benzene diazonium bisulfate, supplied by PCAS, France).

The coating was dried at 95° C. for 5 min and then fed through an Epson Stylus 740 printer, which deposited a pattern of black inks. The imaged plates were washed with tap water to remove the inkjet ink and the coating in the area not covered by the inkjet inks. The coating covered by the inkjet inks remained after water rinsing, and provided ink-receptive portions of a lithographic printing plate. Laboratory analysis of the black ink composition in Epson Stylus 740 revealed that it had pH=9.0 and had the following composition:

| Ingredient | Weight % |
|---|---|
| triethanol amine | 1 |
| diethylene glycol mono butyl ether | 11 |
| glycerol | 11 |
| diethylene glycol | 1 |
| 2-pyrrolidinone | 4.5 |
| water | 72 |

### EXAMPLE 7

5.94 grams of Nega-107, which is a condensation product of 4-4′-bis (methoxymethyl)diphenylether and 4-diazo-3-methoxy diphenylamine isolated as salt of mesitylene sulfonic acid, available from Panchim, France, 0.06 gram of Victoria Blue BO, 56.4 grams of MC, 18.8 grams of MeOH and 18.8 grams of methyl ethyl ketone (MEK) was coated on EG/PVPA substrate using a whirl coater (120RPM at 4 minutes). The resultant plate had a coating weight in the range of 1.0 to 1.2 gr/m². It was evaluated by placing drops of 1.25% solution of hydrazine in water and 5% solution of Kl in water then they were placed in oven at 120° C. for one minute. The coating covered by the above solutions remained after washing with alkaline developer/Finisher solution-“2 in 1”, available from Anitec/KPGraphics. Also, when 1.25% solution of hydrazine gave same results without extra heat step.

### EXAMPLE 8

5.94 grams of N-5000, which is a condensation product of 4-diazo 1 0 diphenylamine sulfate with peraformaldehyde, isolated as a cation of 2-hydroxy-4-methoxy benzophenone-5-sulfonic acid, available from PCAS, France), 0.06 gram of Victoria Blue BO, 56.4 grams of MC, 18.8 grams of MeOH and 18.8 grams of MEK was coated on EG/PVPA substrate using a whirl coater (120RPM at 4 minutes). The resultant plate had a coating IS weight in the range of 1.0 to 1.2 g /m². It was evaluated by placing drops of 5% solution of Kl in water, 1.25% solution of triethanolamine and 1.25% solution of guanidine carbonate in water then they were placed in oven at 120° C. for one minute. The coating covered by the above solutions remained after washing with alkaline developer/Finisher solution-“2 in 1” available from Anitec/Kodak Polychrome Graphics.

### EXAMPLE 9

Vistar-360 plate, available from Kodak Polychrome Graphics, was evaluated by placing drops of 1.25% solution of NH4OH in water, 1.25% solution of guanidine carbonate and 5% solution of triethanolamine in water then they were placed in oven at 120° C. for one minute. The coating covered by the above solutions remained after washing with alkaline developer/Finisher solution-“2 in 1”, available from Anitec/Kodak Polychrome Graphics.

### EXAMPLE 10

Winner plate (available from Kodak Polychrome Graphics) was evaluated by placing drops of 1.25% solution of NH4OH in water, 1.25% solution of guanidine carbonate, 1.25% solution of triethanolamine in water and 1.25% solution of hydrazine in water then they were placed in oven at 120° C. for one minute. The coating covered by the above solutions remained after washing with alkaline developer/Finisher solution-“2 in 1”, available from Anitec/Kodak Polychrome Graphics.

The present invention has been described with particular reference to the preferred embodiments. It should be understood that variations and modifications thereof can be devised by those skilled in the art without departing from the spirit and scope of the present invention. Accordingly, the present invention embraces all such alternatives, modifications and variations that fall within the scope of the appended claims.

What is claimed is:

1. A method of preparing an inkjet ink imaged lithographic printing plate, comprising the steps of:
imagewise applying onto a substrate coated with an inkjet ink reactive coating composition comprising a diazonium material, an inkjet ink to produce an imaged coated substrate, wherein the inkjet ink imaged regions are oleophilic and more developer-insoluble than non-imaged regions; and
contacting said imaged and non-imaged regions of said imaged coated substrate and an aqueous developer to selectively remove said coating from said developer soluble non-imaged regions.

2. The method of claim 1, wherein said substrate is a lithographic substrate made of material selected from the group consisting of aluminum, polyester and paper.

3. The method of claim 2, wherein said lithographic substrate is an aluminum sheet.

4. The method of claim 3, wherein said aluminum sheet is prepared by a method selected from the group consisting of: decreasing, electrochemical roughening, anodizing, treatment with polyvinyl phosphonic acid acid and a combination thereof.

5. The method of claim 1, wherein said diazonium material in said inkjet ink reactive coating composition can be insolubilized by one or more active ingredients of said inkjet ink.

6. The method of claim 5, wherein said diazonium material is a diazonium condensate.

7. The method of claim 6, wherein said diazonium condensate is the condensation product of an aromatic diazonium salt and a condensation agent selected from the group consisting of: formaldehyde, bis-(alkoxymethyl) diphenyl ether and a combination thereof.

8. The method of claim 7, wherein said bis-(alkoxymethyl) diphenyl ether is bis-(methoxymethyl) diphenyl ether.

9. The method of claim 7, wherein said aromatic diazonium salt is selected from the group consisting of: 4-diazodiphenylamine salt, 3-methoxy-4-diazodiphenylamine salt and a combination thereof.

10. The method of claim 7, wherein said aromatic diazonium salt has a counteranion selected from the group consisting of: benzene sulfonate, toluene sulfonate, mesitylene sulfonate, sulfate, bisulfate, chloride, tetrafluoroborate, hexafluorophosphate, hexafluoroantimonate, hexafluoroarsenate, methanesulfonate, trifluoromethane sulfonate, naphthalene sulfonate and alkyl derivatives, zinc chloride, tetraarylborate, alkyltriarylborate, 2-hydroxy-4-methoxybenzophenone-5-sulfonate, dihydrogen phosphate and a combination thereof.

11. The method of claim 6, wherein said diazonium condensate is 4-phenylaminobenzenediazonium bisulfate and formaldehyde condensate.

12. The method of claim 5, wherein said one or more active ingredients of said inkjet ink include nucleophilic material.

13. The method of claim 12, wherein said nucleophilic material is selected from the group consisting of: a base, a reducing agent and a combination thereof.

14. The method of claim 13, wherein said base is an amine selected from the group consisting of: triethylamine, diisopropylamine, triisopropylamine, tributylamine, trioctylamine, dimethylaniline, dimethylaminopyridine, dimethylbenzylamine, tetramethylguanidine, guanidine, triethanolamine and a combination thereof.

15. The method of claim 13, wherein said base is an inorganic base.

16. The method of claim 1, wherein said inkjet ink has high buffering capacity.

17. The method of claim 1, wherein said inkjet ink further comprises a water-miscible organic solvent selected from the group consisting of: N,N-dimethylformamide, N,N-dimethyl acetamide, N-methyl pyrrolidinone, methyl lactate, ethyl lactate, phenoxy ethanol, benzyl alcohol, butoxy ethanol and a combination thereof.

18. The method of claim 1, wherein said inkjet ink comprises: up to 2 wt % of triethanolamine; up to 15 wt % of diethyleneglycol mono butyl ether; up to 15 wt % of glycerol; up to 2 wt % of diethyleneglycol; up to 10 wt % of 2-pyrrolidinone and up to 85 wt % of water.

19. The method of claim 18, wherein said inkjet ink comprises triethanolamine and 2-pyrrolidinone.

20. The method of claim 1, wherein said inkjet ink has a pH of from 7 to about 14.

21. The method of claim 20, wherein said inkjet ink has a pH of about 9.0.

22. The method of claim 1, wherein said developer is water.

23. The method of claim 22, wherein said aqueous developer is an aqueous alkali developer.

24. The method of claim 1, wherein after applying the inkjet ink onto said coated substrate about 1 second to about 30 minutes is allowed to expire before application of the developer.

25. The method of claim 1, wherein prior to application of the developer, the temperature of the inkjet imaged coated substrate is an ambient or super-ambient temperature.

26. The method of claim 1, further comprising:
post curing said developer-insoluble imaged regions.

27. The method of claim 26, wherein said post curing is carried out by a process comprising the steps of:
exposing said imaged and said non-imaged regions to heat, actinic radiation, or a combination thereof.

28. The method of claim 27, wherein said actinic radiation is ultraviolet radiation.

29. The method of claim 27, wherein said step of exposing to heat is carried out at an ambient or super-ambient temperature.

30. The method of claim 27, wherein said step of exposing to heat is carried out for a period of time from about 1 second to about 30 minutes.

31. The method of claim 26, wherein said post curing of said developer-insoluble imaged regions is carried out after removing said developer-soluble imaged regions.

32. A method of preparing an inkjet ink imaged lithographic printing plate, comprising the steps of:
applying onto a substrate an inkjet ink reactive coating composition, which can be insolubilized by one or more active ingredients of said inkjet ink, to produce a coated substrate;
applying onto said coated substrate an inkjet ink image to produce, after a sufficient time at a sufficient temperature, an imaged coated substrate having developer-insoluble imaged regions and developer-soluble non-imaged regions; and
contacting said imaged and non-imaged regions of said imaged coated substrate and a developer to selectively remove said coating from said developer soluble non-imaged regions and produce said inkjet ink imaged lithographic printing plate.

33. A method of preparing an inkjet ink imaged lithographic printing plate, comprising the steps of:
imagewise applying onto a substrate coated with an inkjet ink reactive coating composition comprising a diazonium condensate, which can be insolubilized by one or more active ingredients of said inkjet ink, an inkjet ink to produce, after a sufficient time at a sufficient temperature, an imaged coated substrate having oleophilic developer-insoluble imaged regions and developer-soluble non-imaged regions; and
contacting said imaged and non-imaged regions of said imaged coated substrate and a developer to selectively remove said coating from said developer soluble non-imaged regions.

34. An inkjet ink imaged lithographic printing plate prepared by the method of claim 1.

35. An inkjet ink imaged lithographic printing plate prepared by the method of claim 26.
